(19) United States
(12) Patent Application Publication
(10) Pub. No.: US 2016/0358303 A1
(43) Pub. Date: Dec. 8, 2016

(54) LOW-POWER STATE WITH A VARIABLE REFRESH RATE DISPLAY

(71) Applicant: NVIDIA CORPORATION, Santa Clara, CA (US)

(72) Inventor: Jeffrey F. JULIANO, Cary, NC (US)

(21) Appl. No.: 14/733,744

(22) Filed: Jun. 8, 2015

(51) Int. Cl. G06T 1/20

(52) U.S. Cl. CPC G06T 1/20

(57) ABSTRACT

One embodiment of the present invention sets forth a method for displaying images. The method includes causing a graphics processing unit (GPU) to transmit first display data to a variable refresh rate display at a first refresh rate. The method also includes detecting a level of idleness associated with the display data. The method also includes causing the GPU to enter a low-power state based at least in part on the level of idleness and causing the GPU to exit the low-power state. Finally, the method includes causing the GPU to transmit second display data to the variable refresh rate display to refresh an image displayed on the variable refresh rate display.

### BACKGROUND OF THE INVENTION

Field of the Invention

Embodiments of the present invention relate generally to display systems, and, more specifically, to enabling a low-power state with a variable refresh rate display.

Description of the Related Art

Computer systems typically include some sort of display device, such as a liquid crystal display (LCD) device, coupled to a graphics controller. During normal operation, the graphics controller generates video signals that are transmitted to the display device by scanning-out pixel data from a frame buffer based on timing information generated within the graphics controller. Some display devices have a self-refresh capability, where the display device includes a local controller configured to generate video signals from a static, cached frame of digital video independently from the graphics controller. When in such a self-refresh mode, the video signals are driven by the local controller, thereby allowing portions of the graphics controller to be turned off to reduce the overall power consumption of the computer system. Once in self-refresh mode, when the image to be displayed needs to be updated, control may be transitioned back to the graphics controller to allow new video signals to be generated based on a new set of pixel data.

One drawback with the above approach is that a self-refresh display is needed in order to turn off portions of the graphics controller and enter a low-power state.

Accordingly, what is needed in the art is a technique for entering a low-power state without a self-refresh display.

### SUMMARY OF THE INVENTION

One embodiment of the present invention sets forth a method for displaying images. The method includes causing a graphics processing unit (GPU) to transmit first display data to a variable refresh rate display at a first refresh rate. The method also includes detecting a level of idleness associated with the display data. The method also includes causing the GPU to enter a low-power statebased at least in part on the level of idleness and causing the GPU to exit the low-power state. Finally, the method includes causing the GPU to transmit second display data to the variable refresh rate display to refresh an image displayed on the variable refresh rate display.

Another embodiment of the present invention sets forth a system for displaying images. The system includes a variable refresh rate display operable to display an image and a GPU operable to enter and exit a low-power state, where the GPU enters the low-power state when the image is idle for a predetermined amount of time, and exits the low-power state to refresh the image.

One advantage of the disclosed techniques is that a self-refresh display is not needed to enter the low-power state. Other types of displays may be used to achieve the power savings associated with a low-power state.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 illustrates an example timeline of activity for graphics processing components according to one embodiment of the present invention; and

FIG. 4 is a flow diagram of method steps for entering and exiting a low-power state with a variable refresh rate display, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

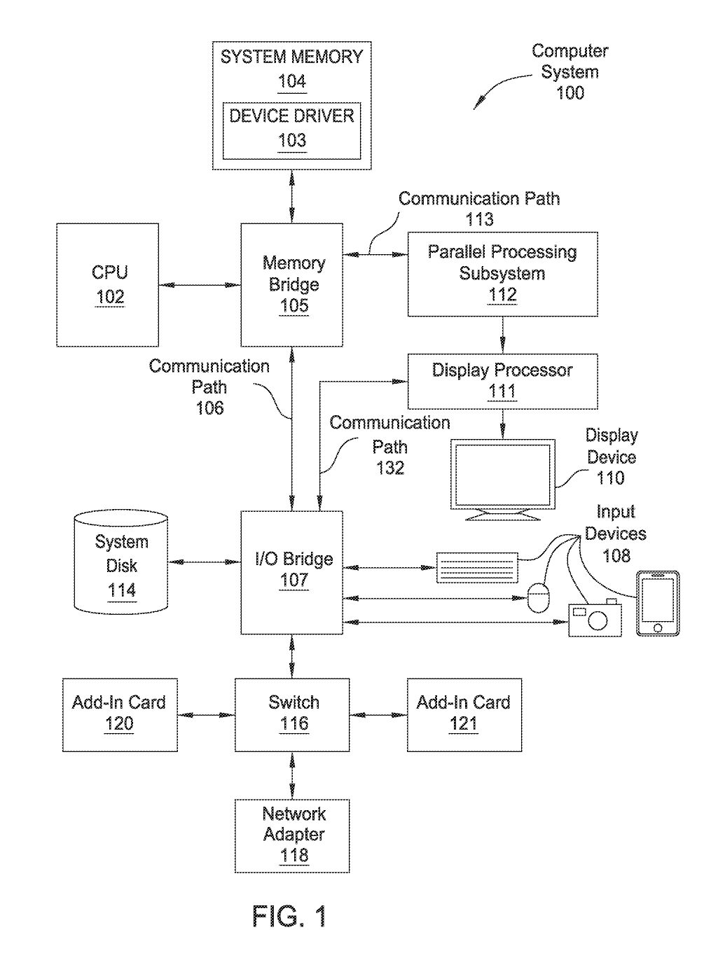

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard, a mouse, and/or a camera and forward the input information to CPU 102 for processing via communication path 106 and memory bridge 105. I/O bridge 107 also may be configured to receive information from an input device 108, such as a camera, and forward the information to a display processor 111 for processing via communication path 132. In addition, I/O bridge 107 may be configured to receive information, such as synchronization signals, from the display processor 111 and forward the information to an input device 108, such as a camera, via communication path 132. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

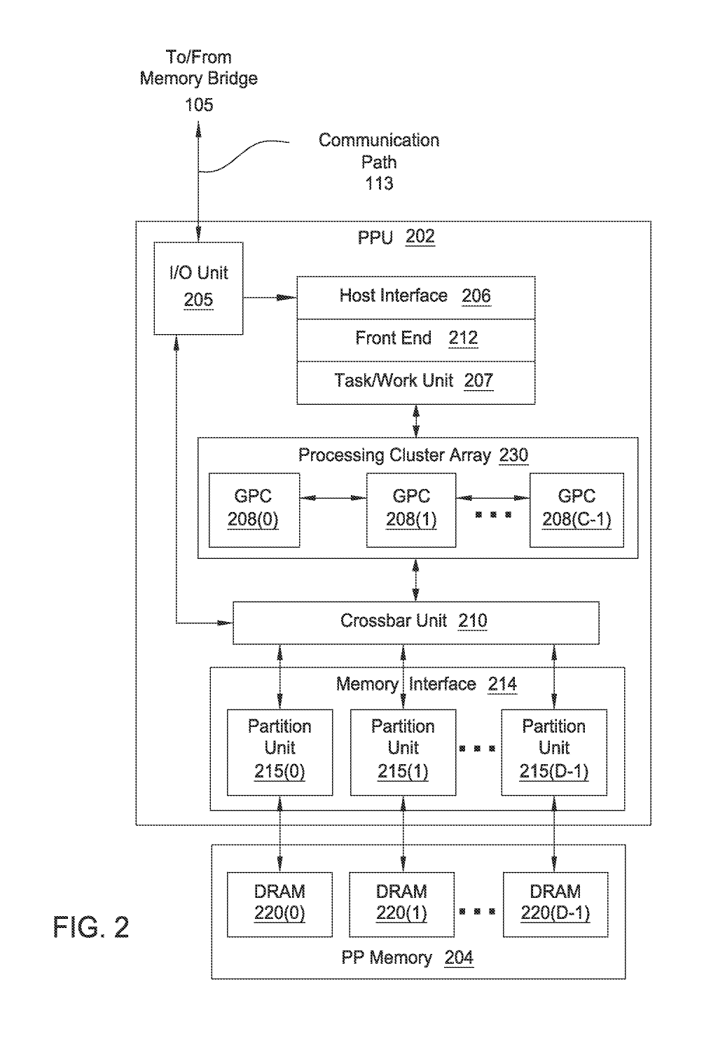

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with the, memory bridge 105, I/O bridge 107, display processor 111, and/or other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Enabling a Low-Power State with a Variable Refresh Rate Display

In the context of this disclosure, and as indicated above, components of computer system 100 shown in FIG. 1 and PPU 202 shown in FIG. 2 may be included within a mobile computing device, such as a notebook or tablet computer. In addition, certain elements of computer system 100 may be incorporated into an SoC, including CPU 102 of FIG. 1 and PPU 202 of FIG. 2, among other elements.

Display devices run at a particular refresh rate, frequently 60 Hz. If the image on the display is unchanging, the same data would need to be sent from a GPU (such as PPU 202 in FIG. 2, above) to a display (such as display device 110 in FIG. 1, above) 60 times per second, which results in wasted power. Self-refresh technology, however, allows certain components to be turned off when the image is not changing, resulting in power savings. For example, the GPU 202 may be turned off or entered into a low-power state. The self-refresh display refreshes the image on the screen using a display-side memory, instead of resending the data from the GPU 202.

In LCD technology, pixels will eventually decay and become a gray color. If too much time passes before the image is refreshed, a viewer may notice a flicker effect. Generally, an LCD panel does not need to be refreshed at 60 Hz to avoid the flicker effect; often, 30 Hz is sufficient.

If a self-refresh display is not available, the image needs to be refreshed with another method at the appropriate times to avoid the flicker effect. In one embodiment, variable refresh rate (VRR) technology can be used with a GPU low-power state to refresh the panel. This embodiment can refresh the display to avoid the flicker effect and also reduce power consumption by entering into a low-power state.

VRR technology involves refreshing a display at different rates rather than a fixed rate. For example, some VRR systems operate between about 30 Hz and 144 Hz. In operation, a GPU continually produces new image data, but generally does not produce data at a constant rate. Rather than sending new data to the display at a fixed rate, a VRR system can send new data when the data is ready, subject to the operating range of the system, such as 30-144 Hz. New display data can be sent to the display immediately instead of at fixed intervals.

In addition, the GPU 202 and/or other components, such as transmitters, receivers, and other hardware, can enter a low-power state when the image on the display does not need to be updated. When new image data is needed, the system can exit the low-power state and send the new image data to the display. The system can also exit the low-power state to send image data when the image on the display is static but the display needs to be refreshed. After sending image data, the system can re-enter the low-power state. Because the low-power state is combined with a VRR system, power consumption can be reduced.

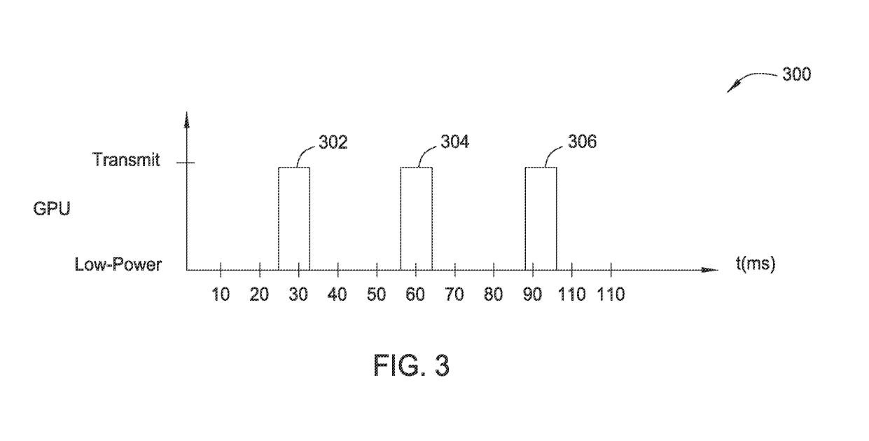

FIG. 3 illustrates an example timeline 300 of activity for graphics processing components according to one embodiment of the present invention. The numbers used in this timeline are exemplary and are for discussion purposes only. Persons skilled in the art will appreciate that the numbers may vary in other embodiments. In this example timeline, the image on the display is static. Also, the display requires a refresh approximately every 32 ms (about 31 Hz). In addition, sending the image data to the display takes around 8 ms. If the image is static, the GPU 202 (and possibly other components, collectively “components”) can enter a low-power state for 24 ms, and then awaken from the low-power state to send a refresh of the unchanged image to the display. After sending the image, which takes about 8 ms, the components can again enter into the low-power state for another 24 ms until the imaged needs refreshed again.

As shown, FIG. 3 illustrates three example refreshes of a static display. The components are in a low-power state for the first 24 ms. At 24 ms, the image is refreshed, which takes about 8 ms as shown in transmission 302. The components are active during that 8 ms transmission window for transmission 302. After transmission of the data to the display is complete, the components again enter the low-power state, at around 32 ms on the example timeline. After 24 ms of idle time, the display again needs to be refreshed (56 ms on the timeline). The components exit the low-power state and transmit image data to the display, which again takes about 8 ms for transmission 304. After transmission 304 (64 ms), the components again enter the low-power state for another 24 ms until the 88 ms mark, for transmission 306. The process continues as long as the image on the display is static. In this example, the components are in the low-power state approximately 75% of the time (24 ms/32 ms).

The pattern of 8 ms up, 24 ms down, 8 ms up, etc., may proceed until the operating system or an application draws a new image for display, at which time the components can exit the low-power state and update the display. Because this system utilizes a VRR display, the GPU 202 can update the image on the display when the image is ready to be updated, without waiting for the next refresh interval like a constant refresh rate system. As an example, the VRR system does not have to wait for the end of the 24 ms interval to send the new image to the display. The image can be sent as soon as it is ready, subject to any hardware limitations, such as the time needed to transmit data across a cable. When the system of FIG. 3 goes idle again after the display is updated, the cycle of 8-24-8-24 ms can begin anew.

A VRR system with a low-power state may also be useful for video playback. As one example, a GPU 202 may take 10 ms to decode a frame of video. The video decoding process can run substantially in parallel with the 8 ms of time needed to transmit the previous frame's image to the display. If the refresh rate is approximately 31 Hz, as in the example embodiment of FIG. 3, that leaves 22 ms of time between screen refreshes for the GPU 202 to enter into the low-power state. This creates a cycle of 10-22-10-22 ms, where the GPU 202 is in a low-power state approximately ⅔ of the time (22 ms/32 ms).

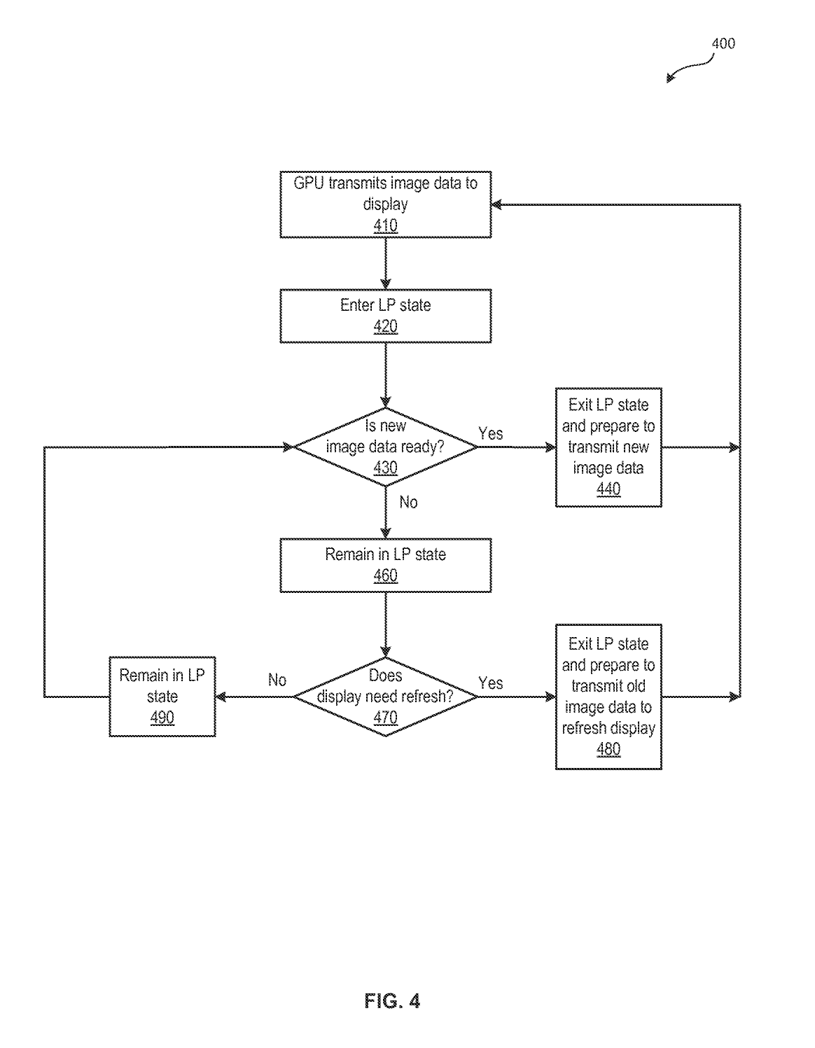

FIG. 4 is a flow diagram of method steps 400 for entering and exiting a low-power state with a variable refresh rate display, according to one embodiment of the present invention. Although the method steps are described in conjunction with FIGS. 1 and 2, persons skilled in the art will understand that any system configured to perform the method steps, in any order, falls within the scope of the present invention. In various embodiments, the hardware and/or software elements described above in FIGS. 1 and 2 can be configured to perform the method steps of FIG. 4.

As shown, a method 400 begins at step 410, where the GPU 202 is operating in a normal, non-low-power state and transmits image data to the display. At step 420, the GPU 202 enters the low-power state (abbreviated “LP state” in the figure). Other components besides the GPU 202 may also enter into a low-power state. Any feasible technique may be used to determine that the GPU 202 and other components should enter the low-power state. As one example, the GPU 202 may monitor the image data sent to the display. If a certain number of consecutive frames of static video are sent to the display, then the components enter the low-power state. As another example, the GPU 202 or other component may detect a level of idleness associated with display data. When the level of idleness reaches a threshold, the system can enter the low-power state. Other conditions may be detected, or other techniques may be used to determine when to enter the low-power state in other embodiments.

At step 430, the GPU 202 determines if new image data is ready. For example, a static image of an idle desktop may need to be updated as a user begins to move a mouse across the display. If new image data such as this is ready for display, the method 400 proceeds to step 440.

At step 440, the GPU 202 exits the low-power state, along with any other components in the low-power state, and the GPU 202 prepares to transmit the new image data to the display. The method 400 then returns to step 410, where the GPU 202, operating in the non-low-power state, transmits the new image data to the display. The GPU 202 continues to cycle through steps 410 through 440, alternating between operating in the low-power state and preparing and transmitting new image data for display while operating in the non-low-power state, until no new image data is ready.

If, at step 430, new image data is not ready for display, then the GPU 202 and other components remain in the low-power state as illustrated in step 460. At step 470, the GPU 202 determines whether the display needs to be refreshed. As discussed above, if the image on the display has been static for a predetermined amount of time, then the image needs to be refreshed to reduce visible flicker. If, at step 470, the display does not need to be refreshed, the GPU 202 and other components remain in the low-power state as illustrated in step 490. The method 400 then returns to step 430, where the GPU determines whether new image data is ready for display.

At step 470, if the specified amount of time for refresh has passed since the last image was sent to the display, then the GPU determines that the display needs to be refreshed and the method 400 proceeds to step 480. At step 480, the GPU 202 exits the low-power state and prepares to transmit the old image data to refresh the display. This process was discussed above with respect to FIG. 3. The method 400 then returns to step 410, where the GPU 202, operating in the non-low-power state, transmits the old image data to the display.

The GPU 202 continues to cycle through steps 410 through 490, alternating between operating in the low-power state and operating in the non-low-power state. While operating in the non-low-power state, the GPU 202 prepares and transmits either new image data or, after a period of inactivity, old image data for display.

In addition to reducing power consumption, performance can also be improved with a VRR system. Instead of sending image data to the display at a constant rate, the image data can be sent when the image data is ready for display. Thus, the VRR system can finish sending data sooner than a constant refresh rate system, because the VRR system does not have to wait until the next cycle to send data; then, after finishing sending the data, the VRR system can enter a low-power state until subsequent image data is available, at which time, the VRR system exits the low-power state and can immediately begin sending the subsequent image data. When the image on the display is static, the VRR system can send data at a rate sufficient to reduce flicker, but lower than rates that might be used to transmit dynamic images. For example, transmitting image data at 30 Hz may be sufficient to reduce flicker while also conserving power by allowing the GPU 202 to stay in the low-power state for a large percentage of the time. However, the VRR system also allows data to be transmitted at a higher rate at other times, like 60 Hz or 120 Hz, which can improve the performance of the display system for a viewer.

In sum, a VRR display may be utilized in a system with a low-power state. A GPU 202 and/or other components may enter the low-power state when the image on the display is idle. The GPU 202 and/or other components may exit the low-power state when image data is ready and transmit the image data to the display at variable rates. The hardware, logic, and algorithms described above may be used to transmit images to a display. Embodiments of the present invention solve existing issues for displaying images.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

1. A method for displaying images, comprising:
causing a graphics processing unit (GPU) to transmit first display data to a variable refresh rate display at a first refresh rate;
detecting a level of idleness associated with the display data;
causing the GPU to enter a low-power state based at least in part on the level of idleness;
causing the GPU to exit the low-power state; and
causing the GPU to transmit second display data to the variable refresh rate display to refresh an image displayed on the variable refresh rate display.

2. The method of claim 1, wherein the second display data is the same as the first display data.

3. The method of claim 1, wherein the second display data is different than the first display data.

4. The method of claim 3, wherein the second display data is transmitted at a second refresh rate, wherein the second refresh rate is greater than the first refresh rate.

5. The method of claim 1, wherein causing the GPU to exit the low-power state comprises causing the GPU to exit the low-power state when a predetermined amount of time has elapsed.

6. The method of claim 5, wherein the image displayed on the variable refresh rate display does not decay within the predetermined amount of time.

7. The method of claim 1, wherein causing the GPU to exit the low-power state comprises causing the GPU to exit the low-power state in order to generate the second display data.

8. The method of claim 1, wherein the GPU decodes video data substantially in parallel with transmitting the first display data and the second display data, and wherein the GPU does not decode video data when the GPU is in the low-power state.

9. A system for displaying images, comprising:
a variable refresh rate display operable to display an image; and
a graphics processing unit (GPU) operable to enter and exit a low-power state, wherein the GPU enters the low-power state when the image is idle for a predetermined amount of time, and exits the low-power state to refresh the image.

10. The system of claim 9, wherein the GPU is configured to exit the low-power state when a new image is ready for display.

11. The system of claim 9, wherein the GPU is configured to exit the low-power state to refresh a static image displayed on the variable refresh rate display.

12. The system of claim 11, wherein the GPU is configured to refresh the static image displayed on the variable refresh rate display when a predetermined amount of time has elapsed.

13. The system of claim 12, wherein the static image displayed on the variable refresh rate display does not decay within the predetermined amount of time.

14. The system of claim 9, wherein the GPU is configured to refresh the image displayed on the variable refresh rate display at a first rate and transmit a new image for display on the variable refresh rate display at a second rate.

15. A computing device configured to display images, including:
a processing unit configured to:
cause a graphics processing unit (GPU) to transmit first display data to a variable refresh rate display at a first refresh rate;
detect a level of idleness associated with the display data;
cause the GPU to enter a low-power state based at least in part on the level of idleness;
cause the GPU to exit the low-power state; and
cause the GPU to transmit second display data to the variable refresh rate display to refresh an image displayed on the variable refresh rate display.

16. The computing device of claim 15, wherein the second display data is the same as the first display data.

17. The computing device of claim 15, wherein the second display data is different than the first display data.

18. The computing device of claim 17, wherein the second display data is transmitted at a second refresh rate, wherein the second refresh rate is greater than the first refresh rate.

19. The computing device of claim 15, wherein causing the GPU to exit the low-power state comprises causing the GPU to exit the low-power state when a predetermined amount of time has elapsed.

20. The computing device of claim 19, wherein the image displayed on the variable refresh rate display does not decay within the predetermined amount of time.
